(19) United States
(12) Patent Application Publication
(10) Pub. No.: US 2011/0110107 A1
(43) Pub. Date: May 12, 2011

(54) HOUSING FOR LIGHTING DEVICE AND LIGHTING DEVICE EQUIPPED WITH SAME

(75) Inventor: Hiroshi Kawato, Chiba (JP)

(73) Assignee: Idemitsu Kosan Co., Ltd., Tokyo (JP)

(21) Appl. No.: 13/000,040

(22) PCT Filed: Jun. 19, 2009
(86) PCT No.: PCT/JP09/61156

§ 371 Date: Dec. 20, 2010

(30) Foreign Application Priority Data
Jun. 24, 2008 (JP) 2008-164470

(51) Int. Cl. F21V 29/00

(52) U.S. Cl. 362/373

(57) ABSTRACT

A lighting device is provided with a substantially bottomed cylindrical-shaped shade base material that defines a reflection space, and a reflector for reflecting light from an LED, the shade base material and the reflector being integrally formed by multi-color injection molding. Since the reflector is formed of a resin, a weight of a lamp housing can be reduced. Moreover, since the shade base material and the reflector are integrally formed by multi-color molding, the number of the manufacturing steps can be reduced. Since the shade base material and the reflector are integrally formed by multi-color injection molding, the lamp housing can be formed in a predetermined stereoscopic shape.

### TECHNICAL FIELD

The present invention relates to a housing for a lighting device and a lighting device equipped with the housing.

### BACKGROUND ART

Recently, environmental problems such as a rising price of crude oil, global warming and inhibition of use of mercury by RoHS (Restriction of Hazardous Substances) have promoted an application of a light-emitting diode (hereinafter, abbreviated as “LED”) light source, which has an excellent energy-saving performance, to general lighting devices.

An attempt is actively made to use an LED light source particularly in a downlight among conventional lighting devices. The downlight includes a lamp housing having a circuit, a heat release fin that is made of an aluminum die-casting and is provided on a rear surface of the circuit, and a reflector for reflecting light of a light source. When the reflector is formed by the aluminum die-casting molding, generally, aluminum or pure silver is vapor-deposited on the reflector or a white coating is provided thereon in order to improve light reflectivity thereof.

A lamp housing with a specific resin sheet is also known as a lighting device having an LED light source (see, for instance, Patent Literature 1).

Patent Literature 1 discloses a lamp housing provided with a multi-layered sheet, in which the multi-layered sheet has a highly reflective layer formed on at least one surface of a base material exhibiting a high rigidity and a high heat-release property. The multi-layered sheet is formed by a thermal molding such as a vacuum molding.

### CITATION LIST

### Patent Literature

Patent Literature 1 JP-A-2008-3254

### SUMMARY OF THE INVENTION

### Problems to be Solved by the Invention

The reflector of the lighting device requires a highly-accurate optical design, and a high size-accuracy when being manufactured. However, when aluminum is used for manufacturing the reflector as traditionally used, size-accuracy and light reflectivity may be decreased. Accordingly, a white coating is further provided on the reflector for improving light reflectivity, which results in increase of assembly steps and manufacturing cost. Further, when aluminum is used, the lighting device itself weighs more to cause difficult handling thereof.

Moreover, such a multi-layered sheet as disclosed in Patent Literature 1 is planarly used, which results in a problem that the multi-layered sheet cannot be used for a stereoscopic lamp housing.

An object of the invention is to provide a housing for a stereoscopic lighting device, and a lighting device therewith while reducing respective weights of the housing and the lighting device and a manufacturing cost.

### Means for Solving the Problems

A housing for a lighting device according to an aspect of the invention includes a shade base material including a reflection space defined therein and a reflective surface facing the reflection space, in which a first end of the shade base material is enlarged and a light source is attachable to a second end thereof in a manner to face the reflection space; and a reflective layer for reflecting light from the light source which is integrally laminated on the shade base material by multi-color molding.

In the aspect of the invention, since the reflective layer is formed of a resin, a weight of the housing can be reduced as compared with a housing with an aluminum reflective layer.

Moreover, since the reflective layer is formed of a resin, the reflective layer can be formed with a high size-accuracy. Accordingly, light reflectivity of the reflective layer can be improved as compared with a reflective layer formed by aluminum die-casting molding.

Further, improvement in light reflectivity can reduce an amount of luminescence of the light source (energy saving).

An operation such as white coating separately performed on the reflective surface in order to improve light reflectivity is not required any longer, thereby preventing increase in manufacturing steps. Moreover, since the shade base material and the reflective layer are integrally formed, the manufacturing steps can be reduced.

Further, since the shade base material and the reflective layer are integrally formed by multi-color injection molding, the housing can be formed in a predetermined stereoscopic shape.

It is preferable that a thermal conductivity of the shade base material is in a range of 3.0 W/m·K to 20 W/m·K.

In the aspect of the invention, since the shade base material has such a specific thermal conductivity, heat release performance of the housing can be improved. When the thermal conductivity of the housing is less than 3.0 W/m·K, the housing may be deformed and luminescence efficiency of LED may decline. On the other hand, when the thermal conductivity of the housing exceeds 20 W/m·K, a mechanical strength and moldability of the shade base material may be impaired.

It is preferable that a total light reflectivity (Y value) of the reflective layer is 95 or more.

In the aspect of the invention, since the resin forming the reflective layer has such a specific Y value, light from the light source can be favorably reflected. When the Y value of the resin forming the reflective layer is less than 95, a luminescence amount needs to be increased by increasing power consumption of the light source, which may not result in energy saving.

A resin material forming such a reflective layer is exemplified by a polycarbonate resin (manufactured by Idemitsu Kosan Co., Ltd., product name: TARFLON URC2501). This polycarbonate resin, which has a thickness of 0.8 mm and UL-94 V-0, exhibits an excellent flame retardance. Since the polycarbonate resin exhibits a relatively high rigidity, rigidity of the housing can be improved.

It is preferable that a heat release fin is integrally laminated on an opposite surface that is opposite to the reflective surface of the shade base material.

In the aspect of the invention, since a specific surface area of the shade base material is increased by the heat release fin, heat release performance of the housing can be improved. Such a heat release fin is preferably formed of a material having a high thermal conductivity such as PPS and PC. When a resin material for forming the heat release fin is the same as a resin material for forming the shade base material, adhesion between the heat release fin and the shade base material can be improved, thereby further releasing heat of the shade base material. Since the shade base material, the reflective layer and the heat release fin are integrally formed by three-color molding, the shade base material, the reflective layer and the heat release fin can be simultaneously manufactured without an additional manufacturing step.

It is preferable that the reflective layer has a flange at a position corresponding to a distal end of the shade base material, the flange protruding oppositely to the reflection space.

In the aspect of the invention, the housing can be attached to a ceiling or a wall via the flange. Since the reflective layer and the flange can be simultaneously formed, there is no need to provide the flange separately to the housing, thereby preventing increase in the manufacturing steps.

When a relatively highly rigid material is used as a material for forming the flange, a screw hole can be formed in the flange, thereby facilitating attachment of the housing to the ceiling and the like.

It is preferable that the heat release fin is formed in a layer including a facing surface that faces the opposite surface and a heat release surface that is opposite to the facing surface, the flange has a flange end laminated on the heat release surface, and the shade base material and the heat release fin are held between the flange end and the reflective layer.

In the aspect of the invention, since the shade base material and the heat release fin are held between the flange end and the reflective layer, adhesion between the shade base material and the heat release fin can be improved, thereby improving rigidity of the housing. By the improved adhesion between the shade base material and the heat release fin, the heat release fin can efficiently release heat of the shade base material, thereby improving heat release performance of the housing.

It is preferable that the light source is a light-emitting diode (LED).

In the aspect of the invention, since the LED has a relatively small amount of heat generation, deterioration of the resin materials for forming the shade base material and the reflective layer can be suppressed even when the LED is kept on emitting for a long time.

A lighting device according to another aspect of the invention includes the above-mentioned housing for a lighting device; and a light source.

In the aspect of the invention, since the lighting device has the above-mentioned housing, a weight of the lighting device can be reduced and the lighting device can be stereoscopically formed while reducing the manufacturing cost.

### BRIEF DESCRIPTION OF DRAWINGS

FIG. 1 is a perspective view of a lighting device as seen from a bottom thereof, according to an exemplary embodiment of the invention.

FIG. 2 is a cross sectional view of the lighting device.

FIG. 3 is a cross sectional view of a lighting device according to another exemplary embodiment of the invention.

### DESCRIPTION OF EMBODIMENTS

A lighting device in an exemplary embodiment(s) of the invention is described below with reference to the attached drawings.

Though a lighting device equipped with an LED is exemplified in the exemplary embodiment of the invention, a lighting device without an LED may be applicable.

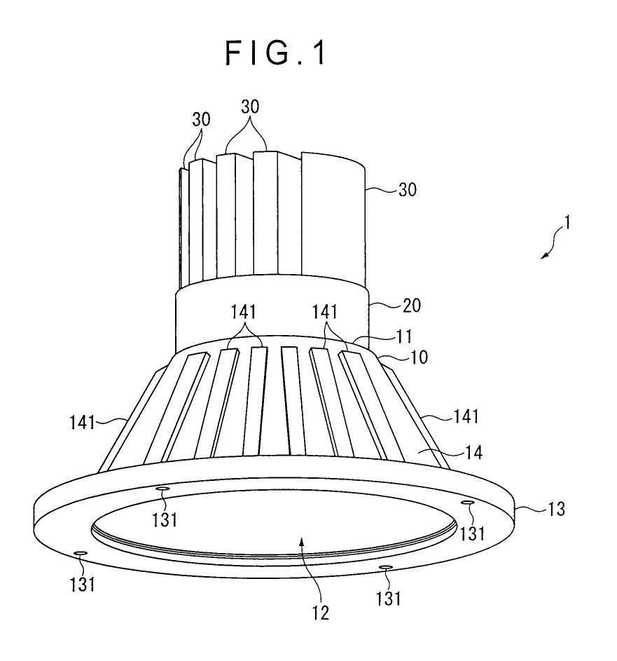

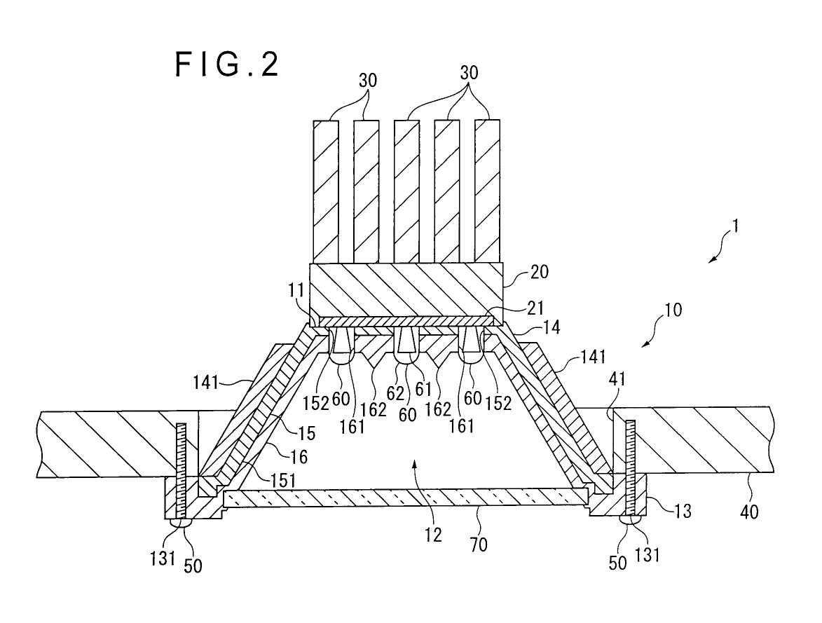

FIG. 1 is a perspective view of a lighting device seen from a bottom thereof, according to the exemplary embodiment of the invention. FIG. 2 is a cross sectional view of the lighting device.

### Structure of Lighting Device

As shown in FIG. 1, a lighting device 1 according to the exemplary embodiment includes: a lamp housing 10 as a substantially bottomed cylindrical-shaped housing in which a first end thereof is enlarged and a second end thereof is closed by a rear end 11; a circuit board accommodating portion 20 that is attached to the rear portion 11 of the lamp housing 10; and a heat release aluminum fin 30 that is made of aluminum and provided on the circuit board accommodating portion 20 in a protruding manner. The lamp housing 10 has a reflection space 12 defined therein. An LED (not shown in FIG. 1) is attached to the rear end 11 in a manner exposed to the reflection space 12. The lighting device 1 emits LED light from an opening via the reflection space 12 of the lamp housing 10. The heat release aluminum fin 30 is formed by a die-casting molding with use of a highly thermally conductive material such as aluminum. The heat release aluminum fin 30 may be formed of polyphenylene sulfide (PPS) having a highly thermally conductivity as well as aluminum.

A flange 13 is formed at a position corresponding to an open distal end of the lamp housing 10. A screw hole 131 is formed on the flange 13.

A heat release fin 141 is formed on a lateral surface 14 (opposite surface) of the lamp housing 10. The heat release fin 141 is elongated from a vicinity of the circuit board accommodating portion 20 to a vicinity of the flange 13. The heat release fins 141 are spaced apart by a predetermined distance from each other.

The reflection space 12 of the lamp housing 10 is formed so as to be enlarged from the circuit board accommodating portion 20 toward the flange 13.

As shown in FIG. 2, the lighting device 1 is inserted into and fixed to a ceiling hole 41. The lighting device 1 is fixed by a tap screw 50 being screwed into a ceiling 40 through the screw hole 131.

A circuit board 21 is provided in the circuit board accommodating portion 20. The circuit board 21 is formed of an insulating and highly heat-releasing material such as PPS. The circuit board 21 is connected to a socket (not shown), to which an LED 60 is attached. The LED 60 includes a reflective material 61 formed of a highly reflective material such as syndiotactic polystyrene (SPS) and a sealing material 62 formed of a resin material such as adamantine acrylate.

The lamp housing 10 includes a shade base material 15 and a reflector 16 laminated on a reflective surface 151 near the reflection space 12 of the shade base material 15, the reflector 16 serving as a reflective layer. Insertion holes 152 and 161 into which the LED 60 can be inserted are respectively formed on the shade base material 15 and the reflector 16 at the rear end 11. A plurality of reflector ribs 162 are formed near the insertion holes 161 of the reflector 16 so as to be substantially as high as a distal end of the LED 60.

The shade base material 15, the reflector 16 and the heat release fin 141 are simultaneously injection-molded by three-color molding. Alternatively, the heat release fin 141 may be laminated on the lateral surface 14 of the shade base material 15 after the shade base material 15 and the reflector 16 are two-color molded.

The reflector 16 is integrally formed with the flange 13. In other words, the flange 13 is formed simultaneously with the formation of the reflector 16. The flange 13 may be connected to the reflector 16 after the shade base material 15 is laminated on the reflector 16.

A light distribution lens 70 is attached to the flange 13. Attachment of the light distribution lens 70 can improve a light distribution performance of the LED 60. Alternatively, a protection glass may be attached in place of the light distribution lens 70. The light distribution lens 70 is exemplified by LE 1700 manufactured by Idemitsu Kosan Co., Ltd. The protection glass is exemplified by methyl methacrylate resin (PMMA).

As the reflector 16, it is preferred to use (i) a porous oriented reflective sheet, (ii) a supercritical foamed reflective sheet, (iii) a multi-layered sheet composed of several hundreds of resin layers with a thickness of ¼λ and different refractive indexes, and (iv) a reflective sheet composed of a titanium oxide-containing thermoplastic resin composition and the like.

(i) is exemplified by a white polyethylene terephthalate (PET) film such as E6SV and E60L manufactured by Toray Industries Inc., and polypropylene (PP) porous oriented film such as White Refstar manufactured by Mitsui Chemicals, Inc. (ii) is exemplified by an ultrafinely foamed light reflective plate MCPET (registered trademark) manufactured by Furukawa Electric Co., Ltd., which is prepared by foaming a polyester film with a supercritical gas so as to have an average cell size of 20 μm or less. (iii) is exemplified by an ESR reflective sheet manufactured by Sumitomo 3M Limited. (iv) is exemplified by a polycarbonate resin composition prepared by blending titanium oxide to a polycarbonate resin in an amount of 30 to 60% by mass.

There is no particular limitation on a resin composition for a light reflective resin layer used for forming the reflector 16, but it is preferred to use a polycarbonate resin composition containing, for instance, a polycarbonate resin or the polymer blend as a matrix resin component, an organopolysiloxane of 0.1 to 5 parts by mass, and, as needed, a flame retardant and flame retardant auxiliary in an amount of 0.1 to 5 parts by mass in total, relative to 100 parts by mass of the polycarbonate resin composition containing titanium oxide in an amount of 8 to 50% by mass. With the use of such a resin composition for a light reflective resin layer, a light reflective resin sheet having excellent reflectance, light blocking effect and light resistance can be provided. A resin material for forming the reflector 16 is exemplified by a polycarbonate resin (manufactured by Idemitsu Kosan Co., Ltd., product name: TARFLON URC2501).

The Y value of a reflected light of the reflector 16 is preferably 95 or more, more preferably 98 or more, further preferably 99 or more. A total light transmittance is preferably 0.5% or less, more preferably 0.2% or less, further preferably 0.1% or less. There is no particular limitation on setting a greater Y value. By setting the Y value as large as possible, a practical brightness characteristic of the reflector 16 is improved.

As the flame retardant, a known one such as a phosphoric ester-based compound and an organopolysiloxane-based compound are usable. As the flame retardant auxiliary, Teflon (registered trademark) is usable as an anti-dripping agent. The total amount of the flame retardant and flame retardant auxiliary to be blended is in a range of 0.1 to 5 parts by mass relative to 100 parts by mass of the polycarbonate resin composition containing titanium oxide in the amount of 8 to 50% by mass. When the total amount of the flame retardant and flame retardant auxiliary is less than 0.1 part by mass, the flame retardance is not exhibited. On the other hand, when the total amount of the flame retardant and flame retardant auxiliary is more than 5 parts by mass, a glass transition temperature excessively declines due to a plasticizing effect thereof, and a heat resistance is impaired. The total amount of the flame retardant and flame retardant auxiliary is preferably in a range of 1 to 4 parts by mass.

A thermal conductivity of the shade base material 15 and the heat release fin 141 is preferably in a range of 3.0 W/m·K to 20 W/m·K, more preferably in a range of 5.0 W/m·K to 10 W/m·K. When the thermal conductivity is less than 3.0 W/m·K, the shade base material 15 and the heat release fin 141 may be deformed. Further, a luminescence efficiency of LED may decline. On the other hand, when the thermal conductivity exceeds 20 W/m·K, a mechanical strength and moldability of the shade base material may be impaired. The shade base material 15 and the heat release fin 141 are preferably formed of a thermoplastic resin composition having a moldability, heat resistance, flame retardance and high thermal conductivity.

The thermoplastic resin composition is preferably a resin composition containing: a thermoplastic resin with a thermal deformation temperature of 120 degrees C. or more, such as a polycarbonate-based resin, PBT-based resin, PET-based resin and polyether sulfone-based resin, or polymer blend containing two or more of the thermoplastic resins, as a matrix resin; a powdered inorganic filler or reinforced fiber in an amount of 5 parts by mass or more relative to 100 parts by mass of the thermoplastic resin; and a flame retardant as needed.

The shade base material 15 and the heat release fin 141 are preferably formed of a thermoplastic resin having a high rigidity. Such a thermoplastic resin is preferably a polycarbonate resin composition containing, when a polycarbonate resin is used as a matrix resin component, an organopolysiloxane 0.1 parts by weight to 5 parts by mass, and, as needed, a flame retardant and flame retardant auxiliary in an amount of 0.1 parts by weight to 5 parts by mass in total relative to 100 parts by mass of the polycarbonate resin composition containing two or more kinds of inorganic fillers of 20% by weight to 60% by mass. Herein, examples of the inorganic fillers include inorganic fillers such as graphite, talc, mica, wollastonite, kaolin, calcium carbonate and hexagonal boron nitride, and reinforced fibers such as glass fiber and carbon fiber, two or more kinds of which may be contained in the inorganic filler.

The shade base material 15 and the heat release fin 141 may be a resin composition containing (A) to (C) below.

(A) polyphenylene sulfide resin of 20 to 60% by weight
(B) hexagonal boron nitride of 8 to 55% by weight
(C) a flat glass fiber of 15 to 55% by weight

The shade base material 15 and the heat release fin 141 may be a resin composition containing (D) to (F) below.

(D) polyphenylene sulfide resin of 20 to 65% by weight
(E) a ceramic filler of 15 to 60% by weight, containing at least one compound of aluminum oxide, magnesium oxide, silicon carbide, aluminum nitride and boron nitride
(F) a fiber of 5 to 45% by weight, containing at least one of glass fiber and carbon fiber

Polyphenylene sulfide is exemplified by polyphenylene sulfide (H1G) manufactured by DIC Corporation.

A heat release performance of the heat release fin 141 can be improved by containing graphite.

### Advantages of Exemplary Embodiment(s)

According to the above-mentioned lighting device, the following advantages can be obtained.

The lighting device 1 of the exemplary embodiment is provided with the substantially bottomed cylindrical-shaped shade base material 15 for forming the reflection space 12, and the reflector 16 for reflecting light from the LED 60, the shade base material 15 and the reflector 16 being integrally formed by multi-color injection molding.

Since the reflector 16 is formed of a resin, the weight of the lamp housing 10 can be reduced as compared with the reflector 16 formed of aluminum. Moreover, since the reflector 16 is formed of a resin, the reflector 16 can be formed with a high size-accuracy. Accordingly, such an operation as separate white-coating on the shade base material 15 is not required, which decreases the number of steps of the operation. Further, since light reflectivity is improved, an amount of luminescence of the LED 60 can be reduced (energy saving). Since the shade base material 15 and the reflector 16 are integrally formed by multi-color molding, the number of the manufacturing steps can be reduced.

Since the shade base material 15 and the reflector 16 are integrally formed by multi-color injection molding, the lamp housing 10 can be formed in a predetermined stereoscopic shape.

A thermal conductivity of the shade base material 15 is in a range of 3.0 W/m·K to 20 W/m·K.

Since the shade base material 15 has such a specific thermal conductivity, heat release performance of the lamp housing 10 can be improved.

The Y value of the reflective layer 16 is 95 or more.

Since the resin forming the reflector 16 has such a specific Y value, light from the light source can be favorably reflected.

Further, the heat release fin 141 is integrally laminated on the lateral surface 14 of the shade base material 15 by multi-color injection molding.

The heat release fin 141 can improve the heat release performance of the lamp housing 10. Since the shade base material 15, the reflector 16 and the heat release fin 141 are formed by three-color molding, the lighting device 1 can be easily manufactured without an additional manufacturing step.

The flange 13 is integrally formed with the reflector 16 at a position corresponding to a distal end of the shade base material 15.

Since the reflector 16 includes the flange 13, the lamp housing 10 can be attached to the ceiling 40, a wall and the like via the flange 13. The lamp housing 10 can be more easily attached to the ceiling 40 and the like via the screw hole 131 of the flange 13.

The lighting device 1 is provided with the LED 60 as a light source.

Since the LED 60 has a relatively small amount of heat generation, deterioration of the resin materials forming the shade base material and the reflective layer can be suppressed even when the LED is kept on emitting for a long time.

The lighting device 1 is provided with the lamp housing 10 and the LED 60.

Since the lighting device 1 is provided with the lamp housing 10, the weight of the lighting device 1 can be reduced and the lighting device 1 can be stereoscopically formed while reducing the manufacturing cost.

### Modification(s) of Exemplary Embodiment(s)

It should be understood that the above-described embodiment is a single exemplary embodiment of the invention and the scope of the invention is not limited to the above-described exemplary embodiment(s) but includes modifications and improvements as long as the modifications and improvements are compatible with the invention. Further, specific arrangements and configurations for carrying out the invention may be altered in any manner within the scope of the object and advantages of the invention.

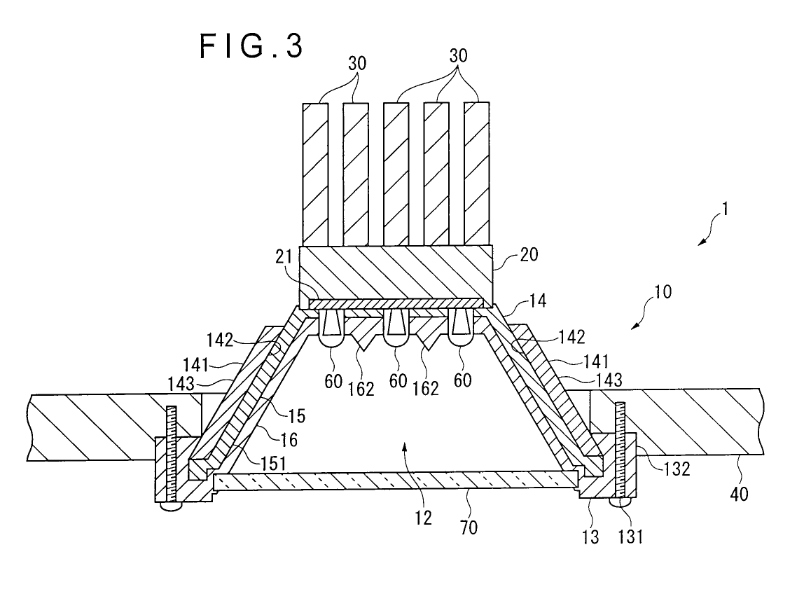

FIG. 3 is a cross sectional view of a lighting device according to another exemplary embodiment of the invention.

In the exemplary embodiment, the flange 13 is provided on a distal end of a lamp housing 10, but an arrangement is not limited to this. For instance, as shown in FIG. 3, the heat release fin 141 includes a facing surface 142 facing the lateral surface 14, and a heat release surface 143 opposite to the facing surface 142. On the heat release surface 143, a flange end 132 of the flange 13 may be laminated.

With this arrangement, since one end of each of the shade base material 15 and the heat release fin 141 is held between the reflector 16 and the flange end 132, adhesion between the reflector 16 and the heat release fin 141 can be improved, thereby improving rigidity of the lamp housing 10. By the improved adhesion between the reflector 16 and the heat release fin 141, the heat release fin 141 can efficiently release heat of the reflector 16 and the shade base material 15, thereby improving heat release performance of the lamp housing 10.

### INDUSTRIAL APPLICABILITY

The present invention is usable for a lighting device such as a street lamp and a car lighting.

### EXPLANATION OF CODES

1 lighting device
10 lamp housing
12 reflection space
13 flange
15 shade base material
151 reflective surface
16 reflector as reflective layer
60 LED
14 lateral surface as opposite surface
141 heat release fin

1. A housing for a lighting device, comprising:
a shade base material comprising a reflection space defined therein and a reflective surface facing the reflection space, wherein a first end of the shade base material is enlarged and a light source is attachable to a second end thereof in a manner to face the reflection space; and
a reflective layer for reflecting light from the light source which is integrally laminated on the shade base material by multi-color molding.

2. The housing for a lighting device according to claim 1, wherein a thermal conductivity of the shade base material is in a range of 3.0 W/m·K to 20 W/m·K.

3. The housing for a lighting device according to claim 1, wherein
a total light reflectivity (Y value) of the reflective layer is 95 or more.

4. The housing for a lighting device according to claim 1, wherein
a heat release fin is integrally laminated on an opposite surface that is opposite to the reflective surface of the shade base material.

5. The housing for a lighting device according to claim 4, wherein
the reflective layer has a flange at a position corresponding to a distal end of the shade base material, the flange protruding oppositely to the reflection space.

6. The housing for a lighting device according to claim 5, wherein
the heat release fin is formed in a layer including a facing surface that faces the opposite surface and a heat release surface that is opposite to the facing surface,
the flange has a flange end laminated on the heat release surface, and
the shade base material and the heat release fin are held between the flange end and the reflective layer.

7. The housing for a lighting device according to claim 1, wherein the light source is a light-emitting diode (LED).

8. A lighting device comprising: the housing for a lighting device according to claim 1;
and a light source.

9. A lighting device comprising: the housing for a lighting device according to claim 2;
and a light source.

10. A lighting device comprising: the housing for a lighting device according to claim 3;
and a light source.

11. A lighting device comprising: the housing for a lighting device according to claim 4;
and a light source.

12. A lighting device comprising: the housing for a lighting device according to claim 5;
and a light source.

13. A lighting device comprising: the housing for a lighting device according to claim 6;
and a light source.

14. A lighting device comprising: the housing for a lighting device according to claim 7;
and a light source.
